(19) United States
(12) Patent Application Publication
(10) Pub. No.: US 2017/0106412 A1
(43) Pub. Date: Apr. 20, 2017

(54) Surface Treatment Device

(71) Applicant: PERI-BAT, Norges-la-Ville (FR)

(72) Inventors: Jean-Pierre Bonneau, Vaux Saules (FR); Cédric Bonneau, Talant (FR); Michael Bonneau, Poncey sur L'ignon (FR); Vincent Bonneau, Chaignay (FR)

(21) Appl. No.: 15/310,983

(22) PCT Filed: May 13, 2015
(86) PCT No.: PCT/FR2015/051268

§ 371 Date: Nov. 14, 2016

(30) Foreign Application Priority Data
May 13, 2014 (FR) 1454229

(51) Int. Cl. B08B 3/02; E04G 23/08; B05B 13/04; B09B 3/00

(52) U.S. Cl. CPC B08B 3/024; B09B 3/0066; E04G 23/081; B05B 13/041; B08B 2203/0229

(57) ABSTRACT

A device for the treatment of a surface, such as a flat and/or curved surface, the device including at least one surface treatment tool mounted onto a secondary motorized carriage capable of moving along a rail between two primary carriages that can move along tubes, preferably parallel, straight or curved. The primary carriages are mounted onto the rail, on the one hand, in such a way as to rotate around an axle that is orthogonal to the rail and, on the other hand, in such a way as to slide along the rail.

### ART

This invention relates to a surface treatment device that is particularly suitable for the treatment of surfaces such as a floor, a ceiling, a wall or a column, for example, covered with a coating containing one or more toxic products such as asbestos, lead (Pb), PCBs (polychlorinated biphenyls) and polycyclic aromatic hydrocarbons (PAHs), for example, present in many products with many applications such as floor and ceiling coatings, wall coverings (paint, insulation, etc.), road surfaces, asphalt adhesives, vapor barriers, sealing materials, treatment plant walls, water tower walls or similar.

### PRIOR ART

Asbestos has been known in the prior art for more than 2,000 years, and has long been used in many materials and products due to its properties of acoustic and thermal insulation, resistance to heat and fire, its chemical inertia, mechanical strength and its rot-proof properties. However, the physiochemical characteristics of asbestos, combined with the ability to split into microscopic split fibers that reach the alveoli, and even migrate up to the pleura, make the over-inhalation of asbestos fibers dangerous. Regulations require that a worker should not inhale more than 0.1 fibers per cm³ per hour. Pathologies, mainly lung cancer, can occur up to more than fifty years after initial exposure to asbestos fibers.

The side effects on human health therefore led to controls on and then a gradual reduction in its use, followed by a total ban from Jan. 1, 1997, by Decree No. 96-1133 of Dec. 24, 1996 relating to the prohibition of asbestos, pursuant to the French Labor Code and the French Consumer Code.

Currently, given that they must respect safety standards for workers and the environment, asbestos removal operations involve several stringent steps. Specifically, a worker must be equipped with coveralls and a respiratory system so as to not inhale friable asbestos dust, which is extremely toxic. Such work is performed in a confined area with access to said confined area being by means of an airlock, divided into several compartments including two showers. The air pressure within this confined area is lower than that of the external air, in such a way that in the event of a leakage, it is the outside air that enters the confined area, and not the reverse. This confined area is implemented by means of two polythene films which protect surfaces that must be prevented from passing asbestos. An air renewal system must also be provided.

It is however common that the coveralls and/or respiratory system can become inoperative during the work, due to a tear in the coveralls or a malfunction within the respiratory system, for example, such that it is common for workers to breathe more than 0.1 fibers per cm³ per hour, thus exposing themselves to deadly diseases. In addition, despite all of the precautions taken during containment, as said containment requires a lot of time for its implementation as well as mandatory audits that considerably strain the costs of asbestos removal sites, some asbestos fibers can escape the containment area, thereby endangering those persons outside the site who are likely to breathe asbestos fibers unknowingly.

Asbestos thus removed from its support may be treated in such a way as to render it inert, i.e. modifying it in order to render it non-toxic to humans. This treatment may consist of vitrification, as described within patents FR 2 853 846 or FR 2 690 093, the asbestos waste being placed within a special furnace for very high temperatures. The waste can be previously packaged, for example by prior bagging, as described within patent FR 2 746 037.

However, the risks of inhalation is greatest during the removal of the asbestos from its support. In this respect, it is customary to use scrapers or sanders to remove asbestos from its support, which produces a large amount of asbestos dust that can be dispersed into the ambient air. Common methods of asbestos removal require draconian safety conditions but without detoxifying the product.

Many alternative solutions have been found that allow for one-step waste removal whilst rendering it inert. This is particularly true of patent U.S. Pat. No. 4,693,755, which describes a method for the removal of asbestos from its support following the application of a composition based upon a cellulose polymer that penetrates and dries asbestos dust in such a way as to render it inert.

This type of method is however no longer implemented in light of the chemical risk it incurs to workers and the environment.

Also known in the prior art is patent FR 2 875 720, which meanwhile describes an asbestos removal method using coldness. After the injection of liquid nitrogen, within a temperature range of between −40° C. and −196° C., asbestos freezes onto its support and can be safely removed.

In addition to the high cost of liquid nitrogen, this type of method requires an additional asbestos fiber treatment step which strains the cost of removal sites.

Also known in the prior art is FR 2 815 276, which describes a device for the removal of asbestos from surfaces comprising an apparatus for the projection of a liquid stream at high pressure, said pressure being between 1,000 and 2,000 bars, at a distance of about one meter from the surface to be treated, separated pumping means for sucking the moisture laden residues resulting from the degradation of the coating that has fallen onto the floor, a filtration system consisting of a plate filter, and possibly a second filtration system.

All of these methods and the devices that implement them have the disadvantage, in addition to being expensive, of producing too high a quantity of asbestos dust such that the risk to workers and the environment remains too high. In addition, Decree No. 2012-639 requires that, as from Jul. 1, 2015, the average concentration of asbestos fibers, during eight hours of work, be no more than 10 fibers per liter. As a consequence there is a division by ten, based upon the previously authorized rate and which places the limit at 100 fibers per liter. Three classification categories are thus implemented. At the “first level”, the amount of dust is lower than the occupational exposure limit value, known as the VLP. At the “second level”, the value is greater than or equal to the VLP and lower than 60 times the VLP. At the “third level”, the value is greater than or equal to 60 times the VLP and lower than 250 times the VLP. Thus, this decrease in the occupational exposure limit value (VLP) will immediately result in an increase in the cost of removing asbestos using the asbestos removal methods of the prior art.

Moreover, within buildings, there are other products that may constitute a health risk and must be removed safely for the health of workers, notably during demolition. It is particularly the case with lead which is likely to cause lead poisoning and is present within many surface coatings notably within old paintings, PCBs (polychlorinated biphenyls) which are similar to dioxin chemicals and are found in expansion joints as well as in some coatings, polycyclic aromatic hydrocarbons (PAHs), which are persistent organic pollutants and are present within products made from bitumen such as road surfaces, asphalt adhesives, vapor barriers, sealing materials, treatment plant walls, water tower walls, etc., and radioactive products that are notably found on cooling towers, reactor enclosures or similar in nuclear power plants.

There is therefore a need for a device for the treatment of surfaces containing one or more toxic products that provides for the removal of said products in complete safety for workers and the environment.

WO 2010/140952 proposes to meet this need by providing a device for the treatment of a flat and/or curved surface, of a type comprising at least one surface treatment tool mounted onto a secondary carriage capable of moving along a rail between two carriages known as primary carriages. The two primary carriages are in contact with parallel tubular rails, and are capable of moving along these rails in order to move the rail carrying the tool and perform the surface treatment. For this purpose, each primary carriage comprises two clamps that enclose the section of one of the tubular rails and that can be moved with respect to one another, outbound or inbound, by means of a cylinder system. For the movement of such a primary carriage along the tubular rail, a first clamp is released, at a distance from the second clamp, and then tightened. Successively, the second clamp is released, brought closer to the first, and then tightened. The rail carrying the tool therefore moves along the tubular rails.

In this way, this solution offers a device for the treatment of surfaces, that is particularly suitable for the treatment of surfaces covered with a coating containing one or more toxic products.

However, this solution has some drawbacks that are inherent to its structure. Specifically, the surface treatment device cited in WO 2010/140952 is not suitable for treating oblique surfaces, for example beneath a staircase. The movement of the surface treatment tool is only performed horizontally, orthogonally to the tubular rails along which the device moves.

A further drawback lies in the fact that the movement of the rail carrying the tool is slow and jerky and presents the risk of sliding, especially when the surface treatment projects water at high pressure notably causing the tubular rails to become wet. Thus, this solution does not allow for the rapid removal of said products in complete safety for workers and the environment.

### DISCLOSURE OF THE INVENTION

One of the objects of the invention is therefore to remedy these drawbacks by offering a surface treatment device that is particularly suitable for the treatment of any type of surface such as a floor, a ceiling, a wall or a column, for example, covered with a coating containing one or more toxic products, of a simple and inexpensive design, and that also allows for the rapid removal of said products found on inaccessible surfaces such as surfaces beneath stairs, for example.

Another object of the invention is to provide a surface treatment device that allows for the rapid removal of products in complete safety for workers and the environment.

To solve the aforementioned problems, a device has been designed for the treatment of a surface, such as a flat and/or curved surface in accordance with the prior art in that it comprises at least one surface treatment tool mounted onto a secondary motorized carriage capable of moving along a rail between two primary carriages that can move along tubes, such as straight or curved tubes, preferably parallel and with a circular section.

It is well understood that a worker will be able to operate the device remotely, in order to prevent the inhalation of any toxic products. The device is particularly suitable for treating flat surfaces when the two tubes upon which the two primary carriages are mounted are straight, and for treating curved surfaces when said tubes are curved.

According to the invention, the primary carriages are mounted onto the rail, on the one hand, in such a way as to rotate around an axle that is orthogonal to said rail and, on the other hand, in such a way as to slide along said rail.

In this way, each primary carriage can rotate in relation to the rail carrying the tool and can move along the rail carrying the tool. In other words, the carriages can move independently along the tubes. It follows that the rail carrying the tool can be arranged diagonally, particularly in order to allow for the rapid and effective treatment of surfaces that are difficult to access such as surfaces beneath stairs, for example. Furthermore, given that said primary carriages have the ability to move closer to or further away from one another by sliding along the rail, the tubes upon which the primary carriages move need not be parallel.

In a specific embodiment, each carriage contains a roller mounted pivotally in relation to the axle integral with said carriage and extending within a longitudinal guide formed within the rail.

In another feature of the invention, independently of the fact that the primary carriages are mounted in such a way as to rotate in relation to the rail and can move along it in order to treat surfaces at an angle, the primary carriages are motorized and comprise drive means capable of resting on the tubes, and rolling along said tubes in order to move said primary carriages.

Thus, the primary carriages roll on tubes by means of drive means resting on said tubes in such a way that the movement is rapid and the risk of sliding is reduced. The drive means remain in contact with and rest upon the surface of the tubes.

In a specific embodiment, said drive means comprise a track, such as a flexible rubber or elastomer track, extending between two sprockets. In this way, the contact surface of the drive means and the tubes is increased and the risk of sliding is reduced. The degree of safety in use is optimal.

Moreover, the drive means contain at least one roller held against an inner wall of the track by a spring in order to tension the track.

Furthermore, each track has a flat inner wall and an outer wall with a concave cross-section in order to accommodate the diameter of the tube.

The curvature radius of the outer track wall with the concave cross-section is substantially equal to the curvature radius of the tube.

Moreover, at least one of the sprockets is driven by a motor, said motor preferably consisting of a hydraulic motor.

In a specific embodiment, each primary carriage consists of at least two boxes, preferably with a handle, extending in parallel to one other and connected by spacer means, one of the boxes being hinged onto the rail, and each box comprising drive means, at least one of which is motorized.

Preferably, said tool consists of a hydroblasting head, for example consisting of a substantially cylindrical housing within which extends a rotating nozzle with holes, said nozzle being fed by water under high pressure by means of a flexible pipe such as to form jets at the outlet of the holes.

Advantageously, the lower edge of the housing has a brush that ensures a seal when the hydroblasting head is pressed against the surface to be treated.

Moreover, said hydroblasting head contains suction pipes connected to a suction source and leading into the housing.

### BRIEF DESCRIPTION OF FIGURES

Further advantages and features will become clearer from the following description of several alternative embodiments, given by way of non-limiting examples, of the surface treatment device according to the invention, with reference to the accompanying drawings in which:

FIG. 1 is a perspective view of the surface treatment device according to the invention,

FIG. 2 is a perspective rear view of a motorized primary carriage of the surface treatment device according to the invention,

FIG. 3 is a perspective forward view of the motorized primary carriage of the surface treatment device according to the invention,

FIG. 4 is an exploded perspective view of the motorized primary carriage of the surface treatment device according to the invention,

FIG. 5 is a rear view of the motorized primary carriage of the surface treatment device according to the invention,

FIG. 6 is a side view of the motorized primary carriage of the surface treatment device according to the invention,

FIG. 7 is a cutaway top view of the motorized primary carriage of the surface treatment device according to the invention,

FIG. 8 is a schematic view showing the surface treatment device arranged diagonally for the treatment of surfaces that are difficult to access such as a staircase, for example.

### DETAILED DESCRIPTION OF THE INVENTION

For clarity, in the following description, the same elements have been designated with the same reference numerals in the various figures. Furthermore, the views are not necessarily drawn to scale. In addition, the device according to the invention is specifically intended for the removal of asbestos; however, it is quite obvious that the device according to the invention can find many applications in the treatment of surfaces containing toxic products without departing from the scope of the invention. In a non-limiting way, said toxic products may consist of lead (Pb), PCBs (polychlorinated biphenyls) and polycyclic aromatic hydrocarbons (PAHs), which are present in many products with many applications such as floor and ceiling coatings, wall coverings (paint, insulation, etc.), road surfaces, asphalt adhesives, vapor barriers, sealing materials, treatment plant walls, water tower walls, etc.

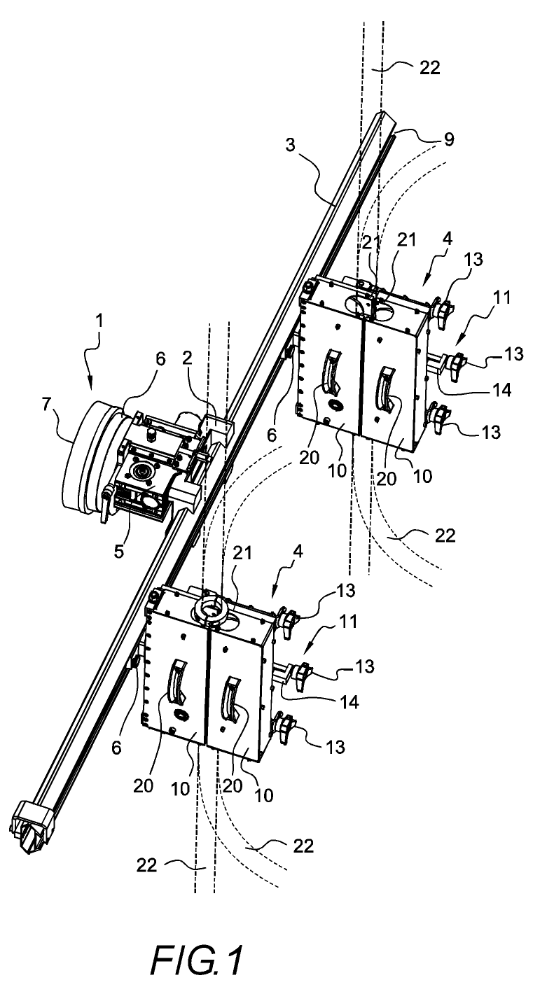

With reference to FIG. 1, the surface treatment device according to the invention consists of a tool (1) mounted onto a carriage (2) known as the secondary carriage, motorized, and capable of moving along a rail (3) between two carriages known as primary carriages (4), motorized, connected to said rail (3) and in contact with two tubes (22).

The tubes (22) extend, preferably, in parallel to each other and can be straight or curved to suit the surface to be treated. The section of the tubes (22) is preferably circular.

The secondary carriage (2) has a hydraulic motor (5) containing drive means, such as a roller or similar, engaging with the rail (3) in order to allow the movement of said secondary carriage (2) along the rail (3). In this specific embodiment, said rail (3) consists of a tube with cross-section profile in the shape of a hexagon; it is however obvious that the rail (3) can have any shape without departing from the scope of the invention.

Preferably, said tool (1) consists of a hydroblasting head. Said hydroblasting head consists of a housing (6) which is substantially cylindrical within which extends a rotating nozzle provided with holes. The nozzle is supplied by water under high pressure through a flexible pipe connected to a high pressure set, not shown in FIG. 1, thereby forming jets at the outlet of said holes. Advantageously, the lower edge of the housing (6) has a brush (7) that ensures a seal when the hydroblasting head is pressed against the surface to be treated. Moreover, said hydroblasting head contains suction pipes connected to a suction source, not shown in FIG. 1, and leading into the housing (6).

Said high pressure set feeding the hydroblasting head delivers a pressure of 600 to 3,000 bars with a water flow of 4 to 28 L/min. Said high pressure set may consist of a high pressure set marketed by RIVARD under the name AQUAJET.

It is clear that the high pressure set can consist of any high pressure set known to the person skilled in the art without departing from the scope of the invention.

Furthermore, said hydroblasting head may, for example, consist of a hydroblasting head marketed by HAMMELMANN under the name AQUABLAST-MORE, for example.

It is clear that the number of holes and their orientation will notably depend upon the pressure provided by the high pressure set and the nature of the surface to be treated, and that a person skilled in the art will have no difficulty in determining the number of holes and their orientations. In addition, it is clear that the tool (1) may consist of any hydroblasting head or any other tool such as a sander, a planer or similar, well-known to a person skilled in the art without departing from the scope of the invention.

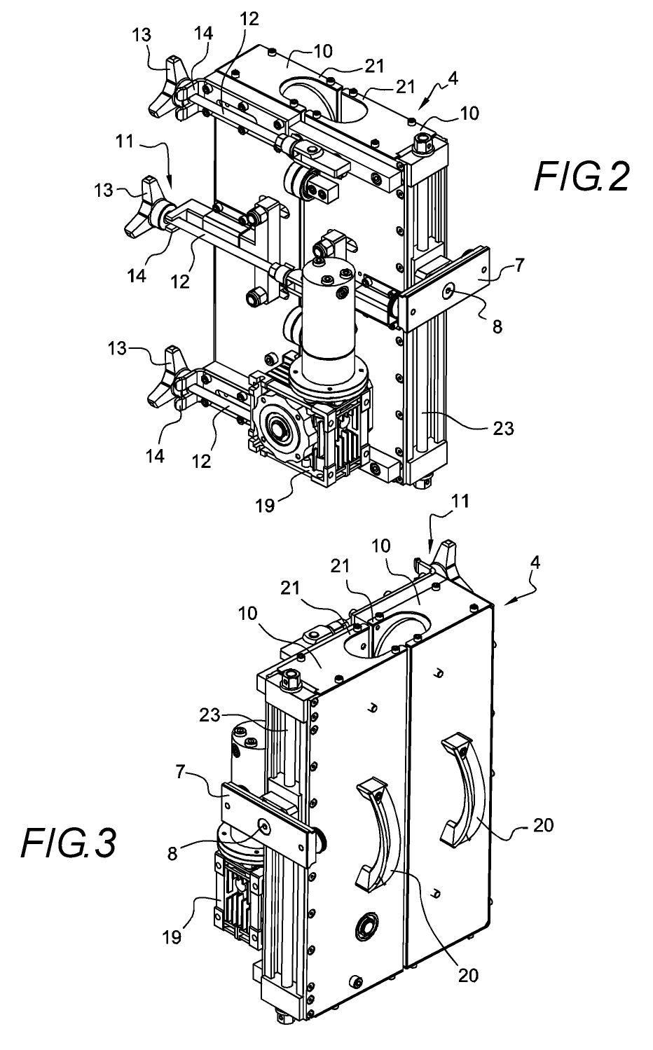

With reference to FIGS. 1 to 3, each primary carriage (4) includes a roller (7) articulated around an axle (8) integral with said primary carriage (4). The roller (7) extends within a guide (9) of the rail (3) such as to allow for the sliding of the primary carriage (4) along the rail (3). Furthermore, each primary carriage (4) can be rotated in relation to the rail (3) carrying the tool, particularly around the axle (8). In reference to FIGS. 2 and 3, the roller (7) and the axle (8) are mounted onto the primary carriage (4) with the capacity of sliding along a rod (23) integral with the primary carriage (4), and oriented in parallel to the tubes (22). In this way, the primary carriage (4) can move in relation to the rail (3), for example in a plane transverse to said rail (3) along said rod (23).

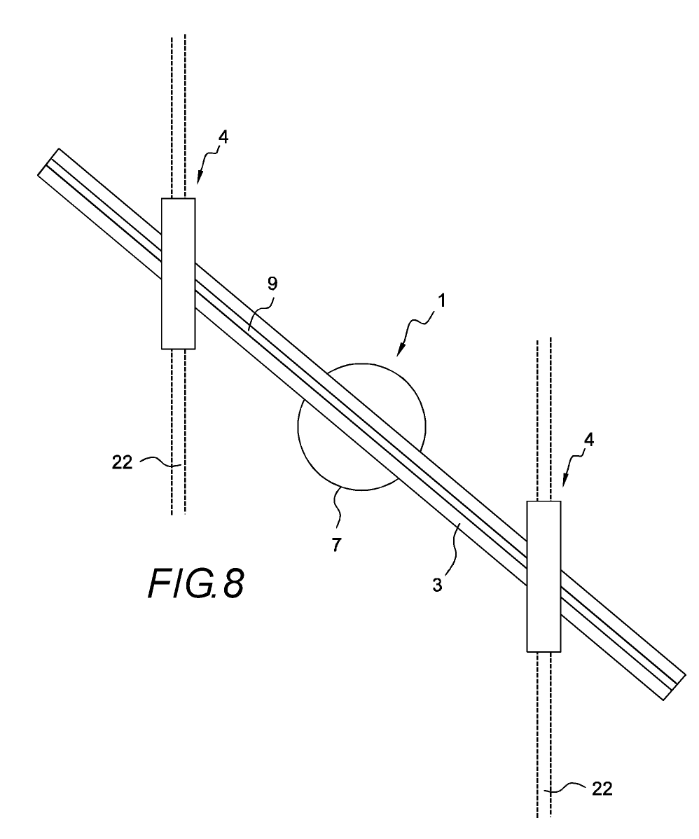

From the foregoing, given that the primary carriages (4) are mounted so as to rotate in relation to the rail (3), and can be moved along it, said primary carriages (4) may move independently along the tubes (22) and be positioned at different heights. It follows, and with reference to FIG. 8, that the rail (3) carrying the tool may be arranged diagonally, particularly in order to treat areas that are difficult to access, such as surfaces beneath stairs, for example.

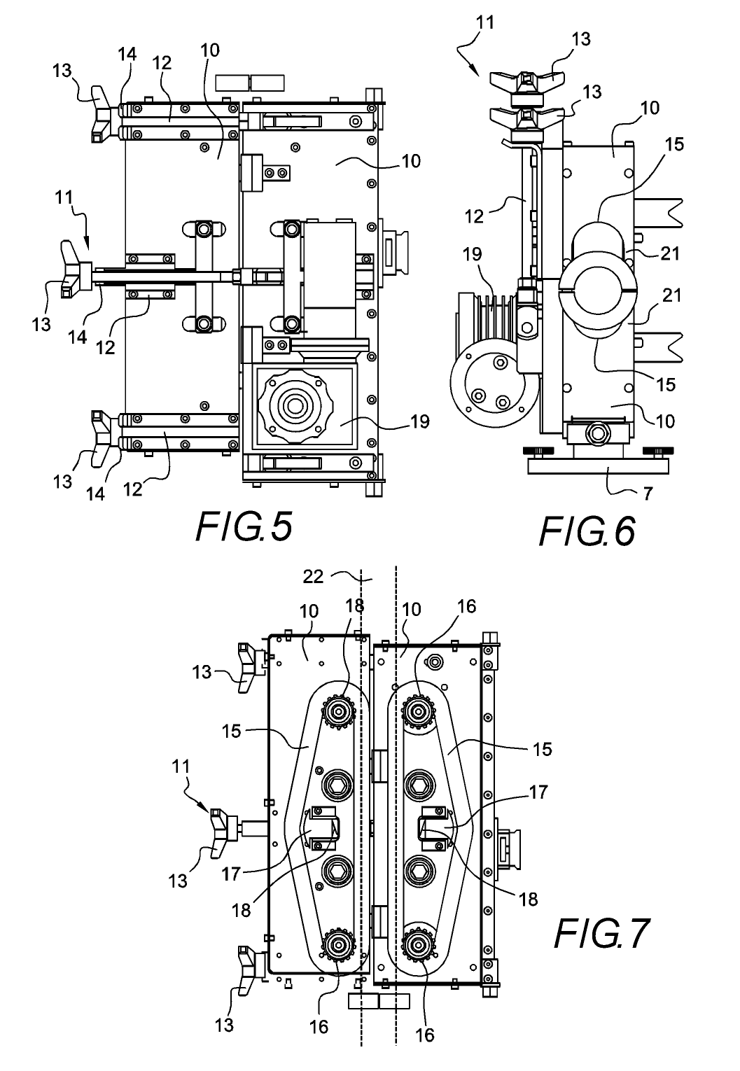

Furthermore, with reference to FIGS. 2 to 7, each primary carriage (4) consists of two rectangular boxes (10) open on one of their sides, extending in parallel to the right of one other, and connected by spacer means (11). One of the boxes (10) carries the roller (7) capable of sliding within the guide (9) of the rail (9), and each box (10) contains drive means, at least one of which is motorized as will be detailed further on.

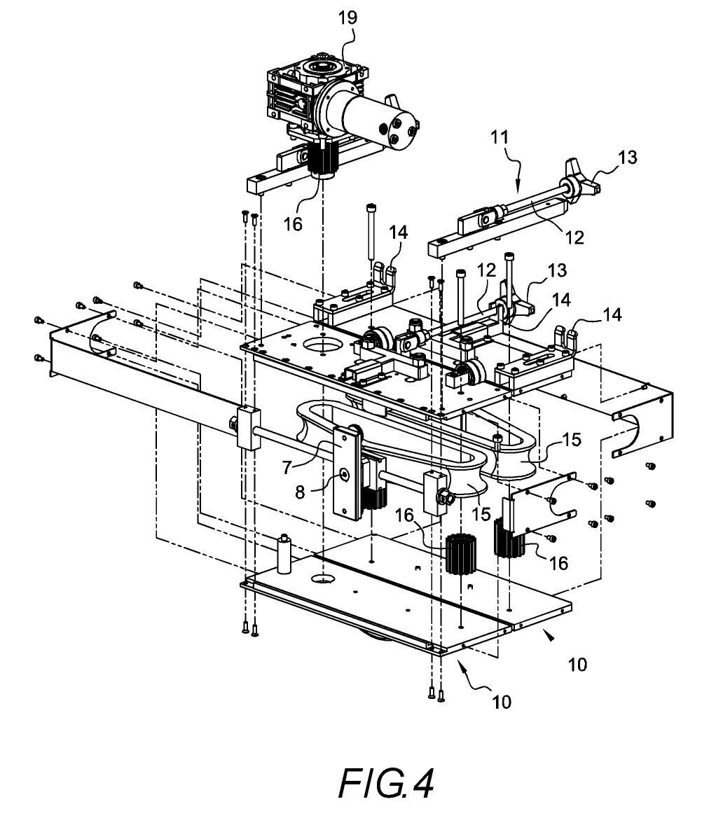

The drive means (11) consist, for example, of threaded rods (12), wherein a first end is hinged at one of the walls of the first box (10) and the other end is fitted with a knob (13) that is designed to rest on a bracket (14) integral with the second box (10). Said drive means consist of a track (15) extending between two sprockets (16), consisting, for example, of toothed cylindrical components, and are mounted such that they can freely rotate between the front and rear walls of said box (10). Moreover, said drive means contain, with reference to FIGS. 4 and 7, at least one roller (17) mounted on a spring (18) in order to tension the track (15). Preferably, each track (15) consists of a soft rubber or elastomer track and presents a flat inner wall and an outer wall of concave cross-section with a curvature radius that is roughly equal to the curvature radius of the tube (22). Moreover, one of the sprockets (16) is driven in rotation by a motor (19), preferably hydraulic, integral with the box (10).

Secondarily, each box (10) comprises a handle (20) to facilitate the spacing of the boxes (10) particularly for maintenance.

Moreover, the side walls of each box (10) have a semicircular notch (21) to allow for the passage of the tube (22) which extends between the two tracks (15) of the two boxes (10) forming the primary carriage (4). Said tracks (15) are supported on said tube (22) and the pressure of said tracks (15) on said tube (22) is adjusted by operating the spacer means (11). The movement of the tracks (15) along the tubes (22) is rapid and secure. The fact that the tracks (15) are always in contact with the tubes (22) and that the spacer means (11) allow for the adjustment of the pressure of said tracks (15) on the tubes (22) ensures the continuous, rapid and secure movement of the device according to the invention along the tubes (22), in particular removing the risk of sliding.

It should be noted that the hydraulic motors (5, 19) will be powered, preferably, by the high-pressure set that feeds the hydroblasting head that constitutes the tool (1) or by a second high-pressure set, with said motors (5, 19) being controlled remotely by any suitable means well known to those skilled in the art.

Thus, it is well understood that a worker can operate the device remotely in order to prevent the inhalation of any toxic products when the tool is in operation.

The device allows for the rapid removal of said products in complete safety for workers and the environment.

Lastly, it is clear that the examples that have just been given are only specific illustrations and by no means limiting as concerns the scope of the invention.

1. A surface treating device, said device comprising at least one surface treatment tool mounted on a secondary motorized carriage capable of moving along a rail between two primary carriages that can move along tubes, characterized in that the primary carriages are mounted on the rail in such a way as to rotate around an axle that is orthogonal to said rail and in such a way as to slide along said rail.

2. The surface treating device according to claim 1, characterized in that each primary carriage contains a roller mounted pivotally in relation to the axle integral with said primary carriage and extending within a longitudinal guide formed with the rail.

3. The surface treating device according to claim 1, characterized in that the primary carriages are motorized and comprise drive mechanisms capable of resting on the tubes, and rolling along said tubes in order to move said primary carriages.

4. The surface treating device according to claim 3, characterized in that the drive mechanisms consist of a track extending between two sprockets.

5. The surface treating device according to claim 4, characterized in that the drive mechanisms contain at least one roller held against an inner wall of the track by a spring in order to tension the track.

6. The surface treating device according to claim 4, characterized in that each track has a flat inner wall and an outer wall with a concave cross-section in order to accommodate a diameter of the tube.

7. The surface treating device according to claim 4, characterized in that at least one of the sprockets is driven in rotation by a motor.

8. The surface treating device according to claim 1, characterized in that each primary carriage consists of at least two boxes extending in parallel to one another and connected by a spacer, one of the boxes being hinged onto the rail and each box containing a drive mechanism, at least one of which is motorized.

9. The surface treating device according to o claim 1, characterized in that said tool consists of a hydroblasting head.

10. The surface treating device according to claim 9, characterized in that the hydroblasting head comprises a cylindrical housing within which extends a rotating nozzle with holes, said nozzle being fed with water under high pressure by way of a flexible pipe so as to form jets at the outlet of the holes.

11. The surface treating device according to claim 10, characterized in that the lower edge of the housing comprises a brush that ensures a seal when the hydroblasting head is pressed against the surface to be treated.

12. The surface treating device according to claim 10, characterized in that said hydroblasting head contains suction pipes connected to a suction source and leading into the housing.
